(19) United States
(12) Patent Application Publication
(10) Pub. No.: US 2026/0337354 A1
(43) Pub. Date: Oct. 29, 2026

(54) FOAM COMPRISING A THERMOPLASTIC POLYURETHANE AND A COPOLYMER HAVING POLYAMIDE BLOCKS AND POLYETHER BLOCKS WITH AMINE END GROUPS

(71) Applicant: ARKEMA FRANCE, Puteaux (FR)

(72) Inventors: Thomas PRENVEILLE, Serquigny (FR); Florent ABGRALL, Serquigny (FR); Blandine TESTUD, Serquigny (FR)

(73) Assignee: ARKEMA FRANCE, Puteaux (FR)

(21) Appl. No.: 19/124,348

(22) PCT Filed: Oct. 26, 2023
(86) PCT No.: PCT/FR2023/051681

§ 371 Date: Apr. 25, 2025

(30) Foreign Application Priority Data
Oct. 26, 2022 (FR) FR2211173

(51) Int. Cl. C08J 9/00; C08G 18/32; C08G 69/40; C08G 69/48; C08G 101/00; C08J 9/12; C08L 77/00

(52) U.S. Cl. CPC C08J 9/0061; C08G 69/48; C08J 9/122; C08L 77/00; C08G 18/3206; C08G 69/40; C08G 2101/00; C08G 2110/0041; C08J 2201/026; C08J 2203/06; C08J 2377/00; C08J 2475/08; C08L 2203/14; C08L 2205/05

(57) ABSTRACT

The invention relates to a polymer foam comprising at least one thermoplastic polyurethane and at least one polyamide block-polyether block copolymer comprising amine chain ends.

The invention also relates to a process for preparing such a foam and also to an article comprising such a foam.

### FIELD OF THE INVENTION

The present invention relates to polymer foams, comprising a thermoplastic polyurethane and a polyamide block-polyether block copolymer bearing amine chain ends, and also to processes for preparing same.

### TECHNICAL BACKGROUND

Various polymer foams are used notably in the field of sports equipment, such as soles or sole components, gloves, rackets or golf balls, personal protection items in particular for practising sports (jackets, interior parts of helmets, shells, etc.).

Such applications require a set of particular physical properties which ensure rebound capacity, a low compression set and a capacity for enduring repeated impacts without becoming deformed and for returning to the initial shape.

WO 2022/162048 relates to expanded particles comprising a first thermoplastic elastomer having a Shore D hardness of from 20 to 90 and a second thermoplastic elastomer. The first thermoplastic elastomer is notably a thermoplastic polyurethane, a thermoplastic polyetheramide, a thermoplastic copolyester, a polyetherester or a polyesterester, and the second thermoplastic elastomer is in particular a thermoplastic polyurethane, a thermoplastic polyetheramide, a polyetherester or a polyesterester or a thermoplastic styrene-butadiene copolymer.

There is a need to provide polymer foams having from a fine, homogeneous cell structure, having a low density, good rebound resilience and also improved flexibility and tear resistance.

### SUMMARY OF THE INVENTION

The invention first relates to a polymer foam comprising:
at least one thermoplastic polyurethane, and
at least one polyamide block-polyether block copolymer comprising amine chain ends, as detected by potentiometric assay in metacresol using a 0.02N perchloric acid solution.

In certain embodiments, at least a portion of the total polyamide block-polyether block copolymer is covalently bonded to a thermoplastic polyurethane molecule via a urea function.

In certain embodiments, the urea function concentration, as measured by ¹³C NMR in DMSO-D₆, is from 0.001 meq/g to 0.1 meq/g, more preferably from 0.003 meq/g to 0.08 meq/g, more preferably from 0.005 meq/g to 0.05 meq/g.

In certain embodiments, the polyamide block-polyether block copolymer has an NH₂ amine function concentration, as measured by potentiometric assay in metacresol using a 0.02N perchloric acid solution, of from 0.002 meq/g to 0.2 meq/g, preferably from 0.005 to 0.1 meq/g.

In certain embodiments, the amount of polyamide blocks, as measured by proton NMR in a TFA/CDCl₃ (¼ v/v) mixture, is at least 15% by weight, preferably at least 25% by weight, relative to the total weight of the foam.

In certain embodiments, the polyamide block-polyether block copolymer comprises at least 30% by weight, preferably at least 40% by weight, of polyamide blocks, relative to the total weight of the copolymer, as measured by proton NMR in a TFA/CDCl₃ (¼ v/v) mixture.

In certain embodiments, the at least one thermoplastic polyurethane is a copolymer containing rigid blocks and flexible blocks, the content of rigid blocks in the thermoplastic polyurethane, as measured by proton NMR in DMSO-D₆, being less than or equal to 90% by weight, more preferably less than or equal to 80% by weight, more preferentially from 30% to 60% by weight.

In certain embodiments, the foam comprises, relative to the total weight of the foam:
from 5% to 70% by weight, preferably from 15% to 60% by weight, even more preferentially from 20% to 45% by weight, of the at least one thermoplastic polyurethane, and
from 30% to 95% by weight, preferably from 40% to 85% by weight, even more preferentially from 55% to 80% by weight, of the at least one polyamide block-polyether block copolymer comprising amine chain ends.

In certain embodiments, the at least one thermoplastic polyurethane is a copolymer containing rigid blocks and flexible blocks, in which:
the flexible blocks are chosen from polyether blocks, polyester blocks, polycarbonate blocks and a combination thereof; preferably, the flexible blocks are chosen from polyether blocks, polyester blocks, and a combination thereof, and are more preferentially polytetrahydrofuran, polypropylene glycol and/or polyethylene glycol blocks; and/or
the rigid blocks comprise units derived from 4,4′-diphenylmethane diisocyanate and/or 1,6-hexamethylene diisocyanate and, preferably, units derived from at least one chain extender chosen from 1,3-propanediol, 1,4-butanediol and/or 1,6-hexanediol.

In certain embodiments, the polyamide blocks of the polyamide block-polyether block copolymer comprising amine chain ends are polyamide 11, polyamide 12, polyamide 10, polyamide 6, polyamide 6.10, polyamide 6.12, polyamide 6.13, polyamide 10.9, polyamide 10.10, polyamide 10.12 and/or polyamide 12.9 blocks, preferably polyamide 11, polyamide 12, polyamide 6, polyamide 6.12, polyamide 6.13, polyamide 10.9 and/or polyamide 12.9 blocks; and/or the polyether blocks of the polyamide block-polyether block copolymer comprising amine chain ends are polyethylene glycol and/or polypropylene glycol and/or polytetrahydrofuran blocks.

In certain embodiments, the foam has a density, as measured at 23 °C in accordance with the standard ISO 1183-1, of less than or equal to 800 kg/m³, preferably less than or equal to 400 kg/m³, more preferentially less than or equal to 300 kg/m³, even more preferentially less than or equal to 230 kg/m³.

In certain embodiments, the foam has an Asker C hardness, as measured at 23 °C according to the standard ISO 7619-1, of from 20 to 90, preferably from 25 to 70.

The invention also relates to a process for manufacturing a foam as described above, involving the following steps:
providing a polymer composition comprising the at least one thermoplastic polyurethane and the at least one polyamide block-polyether block copolymer comprising amine chain ends;
mixing said polymer composition with a blowing agent; and
foaming the mixture of polymer composition and blowing agent.

In certain embodiments, the blowing agent is mixed with the polymer composition in the molten state, with foaming of the mixture preferentially performed in a mold.

In certain embodiments, the blowing agent is a physical blowing agent and is mixed with the polymer composition in the form of a solid preform, the foaming of the mixture preferentially being performed in an autoclave.

The invention also relates to an article formed from a foam as described above or comprising at least one element consisting of a foam as described above, preferably chosen from sports shoe soles, balloons or balls, gloves, personal protective equipment, rail pads, motor vehicle parts, construction parts and electrical and electronic equipment parts.

The present invention serves to meet the need expressed above. More particularly, it provides a regular, homogeneous, low-density polymer foam having improved flexibility and good mechanical properties, notably good tear resistance and good abrasion resistance, while at the same time maintaining high rebound resilience and a relatively low compression set.

This is achieved by using, for formation of the foam, a mixture of a thermoplastic polyurethane (TPU) and a polyamide block-polyether block copolymer having amine (NH₂) chain ends.

In certain advantageous embodiments, covalent bonds are formed between at least a portion of the polyamide block-polyether block copolymer comprising amine chain ends and at least a portion of the thermoplastic polyurethane, and more particularly between the amine functions of the polyamide block-polyether block copolymer and the urethane functions of the thermoplastic polyurethane or the isocyanate functions present in the precursors of the thermoplastic polyurethane. This reaction between at least a portion of the polyamide block-polyether block copolymer comprising amine chain ends and at least a portion of the thermoplastic polyurethane allows improved compatibility between these polymers. This results in improved foamability of the alloys thus obtained, and therefore improved structure (finer, more homogeneous cell structure, lower density) and properties (in particular, higher rebound resilience, lower compression set, higher flexibility) of the foams obtained from these alloys.

### DETAILED DESCRIPTION

The invention is now described in greater detail and in a nonlimiting manner in the description that follows.

Unless otherwise indicated, all the percentages are mass percentages.

In the present text, the amounts indicated for a given species may apply to that species according to all its definitions (as mentioned in the present text), including the more restricted definitions.

The invention first relates to a foam comprising at least one polyamide block-polyether block copolymer comprising amine chain ends and at least one thermoplastic polyurethane.

The presence of amine chain ends in the polyamide block-polyether block copolymer may be detected by potentiometric assay according to the following method: a sample of material is dissolved in metacresol at 80 °C, and then the NH₂ functions of this sample are assayed potentiometrically with a 0.02N perchloric acid solution.

### Polyamide Block-Polyether Block Copolymer (PEBA) Bearing Amine Chain Ends

PEBAs result from the polycondensation of polyamide blocks (rigid or hard blocks) bearing reactive ends with polyether blocks (flexible or soft blocks) bearing reactive ends, in particular from the polycondensation of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks referred to as polyetherdiols.

The polyamide blocks bearing dicarboxylic chain ends originate, for example, from the condensation of polyamide precursors in the presence of a chain-limiting dicarboxylic acid.

Three types of polyamide blocks may advantageously be used.

According to a first type, the polyamide blocks originate from the condensation of a dicarboxylic acid, in particular those containing from 4 to 36 carbon atoms, preferably those containing from 4 to 20 carbon atoms, more preferentially from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and/or PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 18 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 10-aminodecanoic acid, 11-aminoundecanoic acid and 12-aminododecanoic acid.

Advantageously, the polyamide blocks of the second type are PA 10 (polydecanamide), PA 11 (polyundecanamide), PA 12 (polydodecanamide) or PA 6 (polycaprolactam) blocks. In the notation PA X, X represents the number of carbon atoms derived from amino acid residues or lactam residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y),
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 10-aminodecanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid, α,ω-diacid polyoxyalkylenes and dimerized fatty acids. These dimerized fatty acids correspond to the dimerization reaction product of fatty acids (generally containing 18 carbon atoms, often a mixture of oleic and/or linoleic acid); they preferably have a dimer content of at least 98%; preferably, they are hydrogenated; they are preferably a mixture comprising from 0% to 15% by weight of C18 monoacids, from 60% to 99% by weight of C36 diacids, and from 0.2% to 35% by weight of C54 or more triacids or polyacids; they are, for example, products sold under the brand name Pripol by the company Croda, or under the brand name Empol by the company BASF, or under the brand name Radiacid by the company Oleon. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12 in which 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise (or consist of) the polyamide blocks PA 6, PA 10, PA 11, PA 12, PA 5.4, PA 5.9, PA 5.10, PA 5.12, PA 5.13, PA 5.14, PA 5.16, PA 5.18, PA 5.36, PA 6.4, PA 6.6, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, or mixtures or copolymers thereof; and preferably comprise, or consist of, the polyamide blocks PA 6, PA 10, PA 11, PA 12, PA 6.10, PA 6.12, PA 6.13, PA 10.9, PA 10.10, PA 10.12, PA 12.9, or mixtures or copolymers thereof, more preferentially the polyamide blocks PA 6, PA 10, PA 11, PA 12, PA 6.10, PA 6.12, PA 6.13, PA 10.9, PA 12.9, or mixtures or copolymers thereof, even more preferentially the polyamide blocks PA 6, PA 11, PA 12, PA 6.12, PA 6.13, PA 10.9, PA 12.9, or mixtures or copolymers thereof.

The polyether blocks are formed from alkylene oxide units.

The polyether blocks may notably be PEG (polyethylene glycol) blocks, i.e. blocks formed from ethylene oxide units, and/or PPG (polypropylene glycol) blocks, i.e. blocks formed from propylene oxide units, and/or PO3G (polytrimethylene glycol) blocks, i.e. blocks formed from polytrimethylene glycol ether units, and/or PTMG blocks, i.e. blocks formed from tetramethylene glycol units, also known as polytetrahydrofuran. Preferably, the PEBA polyether blocks are polyethylene glycol and/or polypropylene glycol and/or polytetrahydrofuran blocks. The PEBA copolymers may comprise in their chain several types of polyethers, the copolyethers possibly being in block or statistical form.

Use may also be made of blocks obtained by oxyethylation of bisphenols, for instance bisphenol A. The latter products are notably described in EP 613 919.

The polyether blocks may also consist of ethoxylated primary amines. As examples of ethoxylated primary amines, mention may be made of the products of formula:

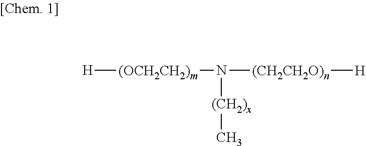

in which m and n are integers between 1 and 20 and x is an integer between 8 and 18. These products are commercially available, for example, under the brand name Noramox® from the company CECA and under the brand name Genamin® from the company Clariant.

The polyether flexible blocks of the PEBA comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, the Jeffamine or Elastamine commercial products may be used (for example Jeffamine® D400, D2000, ED 2003 or XTJ 542, which are commercial products from Huntsman, also described in documents JP 2004346274, JP 2004352794 and EP 1482011).

The polyetherdiol blocks are thus aminated in order to be converted into polyetherdiamines and condensed with polyamide blocks bearing carboxyl ends. The general method for preparing PEBA copolymers having amide bonds between the PA blocks and the PE blocks is known and described, for example in document EP 1482011. The polyether blocks may also be mixed with polyamide precursors and a chain-limiting diacid to prepare polymers containing polyamide blocks and polyether blocks having randomly distributed units (one-step process). Polyetherdiols bearing OH chain ends may be present with the aminated polyetherdiols during their condensation with the polyamide blocks. These polyetherdiols bearing OH chain ends may be condensed with polyamide blocks bearing carboxylic ends, forming ester bonds between the PA blocks and the PE blocks (the products obtained being polyetheresteramides).

Preferably, for the preparation of PEBAs, polyetherdiol blocks are copolycondensed with carboxyl-terminated polyamide blocks.

The general method for the two-step preparation of PEBA copolymers containing ester bonds between the PA blocks and the PE blocks is known and is described, for example, in FR 2846332. The general method for preparing PEBA copolymers bearing amide bonds between the PA blocks and the PE blocks is known and described, for example in EP 1482011. The polyether blocks may also be mixed with polyamide precursors and a chain-limiting diacid to prepare polymers containing polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® PEBA-type products sold by Sanyo or to any other PEBA from other suppliers.

The PEBAs that may be used in the invention include copolymers comprising a single polyamide block and a single polyether block, but also copolymers comprising three, four (or even more) different blocks chosen from those described in the present description, as long as these blocks include at least one polyamide block and one polyether block. In addition, the PEBAs that may be used in include copolymers comprising, in addition to polyamide and polyether blocks, one or more blocks of another nature, in particular chosen from the group consisting of polyester blocks, polysiloxane blocks, such as polydimethylsiloxane (or PDMS) blocks, polyolefin blocks, polycarbonate blocks, and mixtures thereof, preferably chosen from the group consisting of polyester blocks, polysiloxane blocks, and mixtures thereof.

For example, the copolymer may be a segmented block copolymer comprising three different types of blocks (or “triblock” copolymer), which results from the condensation of several of the blocks described above. Said triblock may be, for example, a copolymer comprising a polyamide block, a polyester block and a polyether block or a copolymer comprising a polyamide block and two different polyether blocks, for example a PEG block and a PTMG block.

PEBA copolymers that are particularly preferred in the context of the invention are copolymers including blocks from among: PA 10 and PEG; PA 10 and PTMG; PA 11 and PEG; PA 11 and PTMG; PA 12 and PEG; PA 12 and PTMG; PA 6.10 and PEG; PA 6.10 and PTMG; PA 6 and PEG; PA 6 and PTMG; PA 6.12 and PEG; PA 6.12 and PTMG.

The number-average molar mass of the polyamide blocks in the PEBA copolymer is preferably from 400 to 20 000 g/mol, more preferentially from 500 to 10 000 g/mol. In certain embodiments, the number-average molar mass of the polyamide blocks in the PEBA copolymer is from 400 to 500 g/mol, or from 500 to 600 g/mol, or from 600 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of diacid limiter in excess, MW_{repeating unit} represents the molar mass of the repeating unit, and MW_{chain limiter} represents the molar mass of the diacid in excess.

The number-average molar mass of the polyamide blocks and of the polyether blocks can be measured before the copolymerization of the blocks by gel permeation chromatography (GPC).

Advantageously, the amount of polyamide blocks in the PEBA is at least 10% by weight and preferably at least 20% by weight (relative to the total weight of the PEBA). Even more advantageously, the amount of polyamide blocks in the PEBA is at least 30% by weight, more preferentially at least 40% by weight, even more preferentially at least 50% by weight. The amount of polyamide blocks in the PEBA may be from 10% to 95% by weight (the amount of polyether blocks preferably being from 5% to 90% by weight), preferably from 30% to 90% by weight (the amount of polyether blocks preferably being from 10% to 70% by weight), more preferably from 40% to 85% by weight (the amount of polyether blocks preferably being from 15% to 60% by weight). More particularly, the amount of polyamide blocks in the PEBA may be from 10% to 30% by weight (the amount of polyether blocks preferably being from 70% to 90% by weight), or from 30% to 40% by weight (the amount of polyether blocks preferably being from 60% to 70% by weight), or from 40% to 50% by weight (the amount of polyether blocks preferably being from 50% to 60% by weight), or from 50% to 60% by weight (the amount of polyether blocks preferably being from 40% to 50% by weight), or from 60% to 70% by weight (the amount of polyether blocks preferably being from 30% to 40% by weight), or from 70% to 80% by weight (the amount of polyether blocks preferably being from 20% to 30% by weight), or from 80% to 95% by weight (the amount of polyether blocks preferably being from 5% to 20% by weight). The amount of polyamide blocks in the PEBA may be determined by proton (1H) NMR in a TFA/CDCl₃ (¼ v/v) mixture, preferably using a Bruker A M 500 spectrometer, according to the protocol described in the article “Synthesis and characterization of poly(copolyethers-block-polyamides)—II. Characterization and properties of the multiblock copolymers”, Maréchal et al., Polymer, Volume 41, 2000, 3561-3580 (the signal assignment being performed using FIG. 5 of said article). These amounts afford a foam with lower density, greater flexibility and better rebound resilience.

Advantageously, the PEBA has an NH₂ function concentration of from 0.01 meq/g to 1 meq/g, preferably from 0.02 meq/g to 0.4 meq/g. The PEBA may have an NH₂ function concentration of from 0.01 to 0.015 meq/g, or from 0.015 to 0.02 meq/g, or from 0.02 to 0.025 meq/g, or from 0.025 to 0.03 meq/g, or from 0.03 to 0.035 meq/g, or from 0.035 to 0.04 meq/g, or from 0.04 to 0.045 meq/g, or from 0.045 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g, or from 0.6 to 0.7 meq/g, or from 0.7 to 0.8 meq/g, or from 0.8 to 0.9 meq/g, or from 0.9 to 1 meq/g. The NH₂ function concentration may be measured by potentiometric assay according to the following method: a sample of foam is dissolved in metacresol at 80 °C, and then the NH₂ functions of this sample are assayed potentiometrically with a 0.02N perchloric acid solution.

The PEBA may have a COOH function concentration of from 0.002 meq/g to 0.2 meq/g, preferably from 0.005 meq/g to 0.1 meq/g, more preferably from 0.01 meq/g to 0.08 meq/g. In particular, the PEBA may have a COOH function concentration of from 0.002 to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.15 meq/g, or from 0.15 to 0.2 meq/g. The COOH function concentration may be determined by potentiometric analysis according to the following method: a sample of material is dissolved in benzyl alcohol, and then the COOH functions of this sample are assayed potentiometrically with a 0.02N tetrabutylammonium hydroxide solution.

The PEBA may also comprise hydroxyl (OH) chain ends (originating for example from the condensation of polyetherdiols bearing OH chain ends with polyamide blocks bearing carboxylic ends). In particular, the PEBA may have an OH function concentration (i.e. hydroxyl chain end concentration) of from 0.002 to 0.2 meq/g, preferably from 0.005 to 0.05 meq/g. The OH function concentration may be determined by proton (1H) NMR in a TFA/CDCl₃ (¼ v/v) mixture, preferably using a Bruker A M 500 spectrometer, according to the protocol described in the article “Synthesis and characterization of poly(copolyethers-block-polyamides)—II. Characterization and properties of the multiblock copolymers”, Maréchal et al., Polymer, Volume 41, 2000, 3561-3580 (the signal assignment being performed using FIG. 5 of said article).

Advantageously, the polyamide block-polyether block copolymer has a Shore D hardness greater than or equal to 30. Preferably, the copolymer used in the present invention has an instantaneous hardness of from 65 Shore A to 80 Shore D, more preferably from 75 Shore A to 65 Shore D, more preferentially from 80 Shore A to 55 Shore D. The hardness measurements may be taken according to the standard ISO 7619-1.

### Thermoplastic Polyurethane (TPU)

The thermoplastic polyurethane is a copolymer containing rigid blocks and flexible blocks.

In general, in the present text, the term “rigid block” means a block which has a melting point above 50 °C. The presence of a melting point may be determined by differential scanning calorimetry, according to the standard ISO 11357-3 Plastics—Differential scanning calorimetry (DSC) Part 3. The term “flexible block” means a block with a glass transition temperature (Tg) of less than or equal to 0 °C. The glass transition temperature may be determined by differential scanning calorimetry, according to the standard ISO 11357-2 Plastics—Differential scanning calorimetry (DSC) Part 2.

Thermoplastic polyurethanes result from the reaction of at least one polyisocyanate with at least one isocyanate-reactive compound, preferably containing two isocyanate-reactive functional groups, more preferentially a polyol, and with a chain extender, optionally in the presence of a catalyst. The rigid blocks of the TPU are blocks consisting of units derived from polyisocyanates and chain extenders, while the flexible blocks predominantly comprise units derived from isocyanate-reactive compounds having a molar mass of between 0.5 and 100 kg/mol, preferably polyols.

The polyisocyanate may be aliphatic, cycloaliphatic, araliphatic and/or aromatic. Preferably, the polyisocyanate is aliphatic or aromatic. More advantageously, the polyisocyanate is aliphatic. Preferably, the polyisocyanate is a diisocyanate.

Advantageously, the polyisocyanate is chosen from the group consisting of tri-, tetra-, penta-, hexa-, hepta- and/or octamethylene diisocyanate, 2-methylpentamethylene 1,5-diisocyanate, 2-ethylbutylene 1,4-diisocyanate, 1,5-pentamethylene diisocyanate, 1,4-butylene diisocyanate, 1-isocyanato-3,3,5-trimethyl-5-isocyanatomethylcyclohexane (isophorone diisocyanate, IPDI), 1,4-bis(isocyanatomethyl)cyclohexane, 1,3-bis(isocyanatomethyl)cyclohexane (HXDI), 2,4-paraphenylene diisocyanate (PPDI), 2,4-tetramethylenexylene diisocyanate (TMXDI), 4,4′-, 2,4′- and/or 2,2′-dicyclohexylmethane diisocyanate (H12 MDI), 1,4-cyclohexane diisocyanate, 1-methyl-2,4- and/or 1-methyl-2,6-cyclohexane diisocyanate, 2,2′-, 2,4′- and/or 4,4′-diphenylmethane diisocyanate (MDI), 1,5-naphthylene diisocyanate (NDI), 2,4- and/or 2,6-toluene diisocyanate (TDI), diphenylmethane diisocyanate, 3,3′-dimethyldiphenyl diisocyanate, 1,2-diphenylethane diisocyanate, phenylene diisocyanate, methylenebis(4-cyclohexyl isocyanate) (HMDI) and mixtures thereof.

More preferably, the polyisocyanate is chosen from the group consisting of diphenylmethane diisocyanates (MDI), toluene diisocyanates (TDI), pentamethylene diisocyanate (PDI), hexamethylene diisocyanate (HDI), methylenebis(4-cyclohexyl isocyanate) (HMDI) and mixtures thereof.

Even more preferably, the polyisocyanate is 4,4′-MDI (4,4′-diphenylmethane diisocyanate), 1,6-HDI (1,6-hexamethylene diisocyanate) or a mixture thereof. Even more advantageously, the polyisocyanate is 1,6-HDI.

The isocyanate-reactive compound(s) preferably have an average functionality of between 1.8 and 3, more preferably between 1.8 and 2.6, more preferentially between 1.8 and 2.2. The average functionality of the isocyanate-reactive compound(s) corresponds to the number of isocyanate-reactive functions of the molecules, calculated theoretically for one molecule from an amount of compounds. Preferably, the isocyanate-reactive compound has, according to a statistical average, a Zerewitinoff active hydrogen number in the above ranges.

Preferably, the isocyanate-reactive compound (preferably a polyol) has a number-average molar mass of from 500 to 100 000 g/mol. The isocyanate-reactive compound may have a number-average molar mass ranging from 500 to 8000 g/mol, preferably from 700 to 6000 g/mol, more particularly from 800 to 4000 g/mol. In certain embodiments, the isocyanate-reactive compound has a number-average molar mass ranging from 500 to 600 g/mol, or from 600 to 700 g/mol, or from 700 to 800 g/mol, or from 800 to 1000 g/mol, or 1000 to 1500 g/mol, or 1500 to 2000 g/mol, or 2000 to 2500 g/mol, or 2500 to 3000 g/mol, or 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 10 000 g/mol, or from 10 000 to 15 000 g/mol, or from 15 000 to 20 000 g/mol, or from 20 000 to 30 000 g/mol, or from 30 000 to 40 000 g/mol, or from 40 000 to 50 000 g/mol, or from 50 000 to 60 000 g/mol, or from 60 000 to 70 000 g/mol, or from 70 000 to 80 000 g/mol, or from 80 000 to 100 000 g/mol. The number-average molar mass may be determined by GPC, preferably according to the standard ISO 16014-1:2012.

Advantageously, the isocyanate-reactive compound has at least one reactive group chosen from hydroxyl, amine, thiol and carboxylic acid groups. Preferably, the isocyanate-reactive compound has at least one hydroxyl reactive group, more preferentially several hydroxyl groups. Thus, in a particularly advantageous manner, the isocyanate-reactive compound comprises or consists of a polyol.

Preferably, the polyol is chosen from the group consisting of polyester polyols, polyether polyols, polycarbonate diols, polysiloxane diols, polyalkylene diols and mixtures thereof. More preferably, the polyol is a polyether polyol, polyester polyol and/or polycarbonate diol, so that the flexible blocks of the thermoplastic polyurethane are polyether blocks, polyester blocks and/or polycarbonate blocks, respectively. Preferably also, the flexible blocks of the thermoplastic polyurethane are polyether blocks and/or polyester blocks (the polyol being a polyether polyol and/or a polyester polyol).

As polyester polyols, mention may be made of polycaprolactone polyols and/or copolyesters based on one or more carboxylic acids chosen from adipic acid, succinic acid, pentanedioic acid and/or sebacic acid and one or more alcohols chosen from 1,2-ethanediol, 1,3-propanediol, 1,4-butanediol, 1,5-pentanediol, 3-methyl-1,5-pentanediol, 1,6-hexanediol and/or polytetrahydrofuran. More particularly, the copolyester may be based on adipic acid and a mixture of 1,2-ethanediol and 1,4-butanediol, or the copolyester may be based on adipic acid, succinic acid, pentanedioic acid, sebacic acid or mixtures thereof, and polytetrahydrofuran (tetramethylene glycol), or the copolyester may be a mixture of these copolyesters.

As polyether polyol, polyetherdiols (i.e. aliphatic α,ω-dihydroxylated polyoxyalkylene blocks) are preferably used. Preferably, the polyether polyol is a polyether diol based on ethylene oxide, propylene oxide and/or butylene oxide, a block copolymer based on ethylene oxide and propylene oxide, a polyethylene glycol, a polypropylene glycol, a polybutylene glycol, a polytetrahydrofuran, a polybutane diol or a mixture thereof. The polyether polyol is preferably a polytetrahydrofuran (flexible blocks of the thermoplastic polyurethane thus being polytetrahydrofuran blocks) and/or a polypropylene glycol (flexible blocks of the thermoplastic polyurethane thus being polypropylene glycol blocks) and/or a polyethylene glycol (flexible blocks of the thermoplastic polyurethane thus being polyethylene glycol blocks), preferably a polytetrahydrofuran having a number-average molar mass of from 500 to 15 000 g/mol, preferably from 1000 to 3000 g/mol. The polyether polyol may be a polyether diol which is the product of reaction of ethylene oxide and propylene oxide; the mole ratio of ethylene oxide to propylene oxide is preferably from 0.01 to 100, more preferentially from 0.1 to 9, more preferentially from 0.25 to 4, more preferentially from 0.4 to 2.5, more preferentially from 0.6 to 1.5 and is more preferentially 1.

The polysiloxane diols that may be used in the invention preferably have a number-average molar mass of from 500 to 15 000 g/mol, preferably from 1000 to 3000 g/mol. The number-average molar mass may be determined by GPC, preferably according to the standard ISO 16014-1:2012. Advantageously, the polysiloxane diol is a polysiloxane of formula (I):

[Chem. 2]

HO—[R—O]ₙ—R—Si(R′)₂—[O—Si(R′)₂]ₘ—O—Si(R′)₂—R—[O—R]ₚ—OH (I)
in which R is preferably a C₂-C₄ alkylene, R′ is preferably a C₁-C₄ alkyl and each of n, m and p independently represents an integer preferably between 0 and 50, m ranging more preferentially from 1 to 50, even more preferentially from 2 to 50. Preferably, the polysiloxane has the formula (II) below:

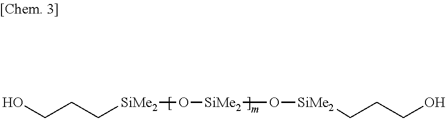

in which Me is a methyl group,
or the formula (III) below:

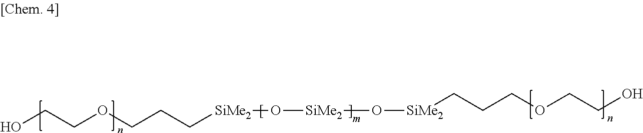

The polyalkylene diols that may be used in the invention are preferably butadiene-based.

The polycarbonate diols that may be used in the invention are preferably aliphatic polycarbonate diols. The polycarbonate diol is preferably alkanediol-based. Preferably, it is strictly difunctional. The preferred polycarbonate diols are those based on butanediol, pentanediol and/or hexanediol, in particular 1,4-butanediol, 1,5-pentanediol, 1,6-hexanediol, 3-methylpentane-(1,5)-diol, or mixtures thereof, more preferentially based on 1,4-butanediol, 1,5-pentanediol, 1,6-hexanediol, or mixtures thereof. In particular, the polycarbonate diol may be a polycarbonate diol based on butanediol and hexanediol, or based on pentanediol and hexanediol, or based on hexanediol, or may be a mixture of two or more of these polycarbonate diols. The polycarbonate diol advantageously has a number-average molar mass ranging from 500 to 4000 g/mol, preferably from 650 to 3500 g/mol, more preferentially from 800 to 3000 g/mol. The number-average molar mass may be determined by GPC, preferably according to the standard ISO 16014-1:2012.

One or more polyols may be used as isocyanate-reactive compounds.

In a particularly preferred manner, the flexible blocks of the TPU are polytetrahydrofuran, polypropylene glycol and/or polyethylene glycol blocks.

A chain extender is used for the preparation of the thermoplastic polyurethane, in addition to the isocyanate and the isocyanate-reactive compound.

The chain extender may be aliphatic, araliphatic, aromatic and/or cycloaliphatic. Advantageously, it has a number-average molar mass of from 50 to 499 g/mol. The number-average molar mass may be determined by GPC, preferably according to the standard ISO 16014-1:2012. The chain extender preferably has two isocyanate-reactive groups (also known as “functional groups”). A single chain extender or a mixture of at least two chain extenders may be used.

The chain extender is preferably difunctional. Examples of chain extenders are diamines and alkanediols containing from 2 to 10 carbon atoms. In particular, the chain extender may be chosen from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane, neopentyl glycol, hydroquinonebis(beta-hydroxyethyl) ether (HQEE), di-, tri-, tetra-, penta-, hexa-, hepta-, octa-, nona- and/or deca-alkylene glycol, their respective oligomers, polypropylene glycol and mixtures thereof. More preferentially, the chain extender is chosen from the group consisting of 1,2-ethylene glycol, 1,3-propanediol, 1,4-butanediol, 1,5-pentanediol, 1,6-hexanediol, and mixtures thereof, and more preferably is chosen from 1,3-propanediol, 1,4-butanediol and/or 1,6-hexanediol. Even more preferentially, the chain extender is a mixture of 1,4-butanediol and 1,6-hexanediol, more preferentially in a mole ratio of from 6:1 to 10:1.

Advantageously, a catalyst is used to synthesize the thermoplastic polyurethane. The catalyst serves to accelerate the reaction between the NCO groups of the polyisocyanate and the isocyanate-reactive compound (preferably with the hydroxyl groups of the isocyanate-reactive compound) and with the chain extender.

The catalyst is preferably a tertiary amine, more preferentially chosen from triethylamine, dimethylcyclohexylamine, N-methylmorpholine, N,N′-dimethylpiperazine, 2-(dimethylaminoethoxy)ethanol and/or diazabicyclo(2,2,2)octane. Alternatively, or additionally, the catalyst is an organometallic compound such as a titanium acid ester, an iron compound, preferably ferric acetylacetonate, a tin compound, preferably those of carboxylic acids, more preferentially tin diacetate, tin dioctoate, tin dilaurate or dialkyltin salts, preferably dibutyltin diacetate and/or dibutyltin dilaurate, a bismuth carboxylic acid salt, preferably bismuth decanoate, or a mixture thereof.

More preferably, the catalyst is chosen from the group consisting of tin dioctoate, bismuth decanoate, titanium acid esters and mixtures thereof. More preferably, the catalyst is tin dioctoate.

When preparing thermoplastic polyurethane, the mole ratios of the isocyanate-reactive compound and the chain extender can be varied to adjust the hardness and melt flow index of the TPU. Specifically, when the proportion of chain extender increases, the hardness and melt viscosity of the TPU increase, whereas the melt flow index of the TPU decreases. For the production of flexible TPU, preferably TPU with a Shore A hardness of less than 95, more preferentially from 75 to 95, the isocyanate-reactive compound and the chain extender can be used in a mole ratio of from 1:1 to 1:5, preferably 1:1.5 to 1:4.5, preferably so that the mixture of isocyanate-reactive compound and chain extender has a hydroxyl equivalent weight of greater than 200, more particularly from 230 to 650, even more preferentially from 230 to 500. For the production of a harder TPU, preferably a TPU with a Shore A hardness of greater than 98, preferably a Shore D hardness from 55 to 75, the isocyanate-reactive compound and the chain extender may be used in a mole ratio of from 1:5.5 to 1:15, preferably from 1:6 to 1:12, so that the mixture of isocyanate-reactive compound and chain extender has a hydroxyl equivalent weight of from 110 to 200, more preferentially from 120 to 180.

Advantageously, to prepare the TPU, the polyisocyanate, the isocyanate-reactive compound and the chain extender are reacted, preferably in the presence of a catalyst, in amounts such that the ratio of the NCO group equivalent of the polyisocyanate to the sum of the hydroxyl groups of the isocyanate-reactive compound and the chain extender is from 0.95:1 to 1.10:1, preferably from 0.98:1 to 1.08:1, more preferably from 1:1 to 1.05:1. The catalyst is advantageously present in an amount of from 0.0001 to 0.1 part by weight per 100 parts by weight of the TPU synthesis reagents.

The TPU preferably has a weight-average molar mass greater than or equal to 10 000 g/mol, preferably greater than or equal to 40000 g/mol and more preferentially greater than or equal to 60 000 g/mol. Preferably, the weight-average molar mass of the TPU is less than or equal to 80 000 g/mol. In certain embodiments, the weight-average molar mass of the TPU is from 10 000 to 25 000 g/mol, or from 25 000 to 40 000 g/mol, or from 40 000 to 50 000 g/mol, or from 50 000 to 60 000 g/mol, or from 60 000 to 70 000 g/mol, or from 70 000 to 80 000 g/mol. The weight-average molar masses may be determined by gel permeation chromatography (GPC).

The rigid block content in the TPU is preferably less than or equal to 90% by weight and more preferably less than or equal to 80% by weight (relative to the total weight of the TPU). More advantageously, the rigid block content in the TPU is from 30% to 60% by weight (the flexible block amount being from 40% to 70% by weight). More particularly, the content of rigid blocks in the TPU may be 10% to 20% by weight (the amount of flexible blocks being from 80% to 90% by weight), or from 20% to 30% by weight (the amount of flexible blocks being from 70% to 80% by weight), or from 30% to 40% by weight (the amount of flexible blocks being from 60% to 70% by weight), or from 40% to 50% by weight (the amount of flexible blocks being from 50% to 60% by weight), or from 50% to 60% by weight (the amount of flexible blocks being from 40% to 50% by weight), or from 60% to 70% by weight (the amount of flexible blocks being from 30% to 40% by weight), or from 70% to 80% by weight (the amount of flexible blocks being from 20% to 30% by weight), or from 80% to 90% by weight (the amount of flexible blocks being from 10% to 20% by weight). These amounts afford a foam with lower density, greater flexibility and better rebound resilience. The content of rigid blocks, expressed as a percentage, is defined in the following manner: [(mass fraction of polyisocyanates+mass fraction of chain extender)/(mass fraction of polyisocyanates+mass fraction of chain extender+mass fraction of isocyanate-reactive compounds)]×100

It may be measured by proton NMR in DMSO-D₆, according to the protocol described in the article: “Reactivity of isocyanates with urethanes: Conditions for allophanate formation”, Lapprand et ak., Polymer Degradation and Stability, Volume 90, No. 2, 2005, 363-373.

Advantageously, the TPU is semicrystalline. Its melting point Tf is preferably between 100 °C and 230 °C, and more preferably between 120 °C and 200 °C. The melting point may be measured according to the standard ISO 11357-3 Plastics—Differential scanning calorimetry (DSC) Part 3.

Advantageously, the TPU may be a recycled TPU and/or a partially or totally biobased TPU.

Advantageously, the TPU has a melt flow index (MFI) of from 10 to 100 g/10 min, preferably from 25 to 80 g/10 min, more preferentially from 35 to 65 g/10 min. In particular, the melt flow index of the TPU may be from 10 to 25 g/10 min, or from 25 to 35 g/10 min, or from 35 to 45 g/10 min, or from 45 to 55 g/10 min, or from 55 to 65 g/10 min, or from 65 to 80 g/10 min, or from 80 to 100 g/10 min. The melt flow index is measured at 200 °C under a 10 kg load, according to the standard ASTM D1238.

Preferably, the TPU has a Shore D hardness of less than or equal to 75, more preferentially less than or equal to 65. In particular, the TPU used in the invention may have a hardness of 65 Shore A to 70 Shore D, preferably 75 Shore A to 60 Shore D. The hardness measurements may be performed according to the standard ISO 7619-1.

Advantageously, the TPU according to the invention has an OH function concentration of from 0.002 meq/g to 0.6 meq/g, preferably from 0.01 meq/g to 0.4 meq/g, more preferably from 0.03 meq/g to 0.2 meq/g. In certain embodiments, the TPU has an OH function concentration of from 0.002 to 0.005 meq/g, or from 0.005 to 0.01 meq/g, or from 0.01 to 0.02 meq/g, or from 0.02 to 0.04 meq/g, or from 0.04 to 0.06 meq/g, or from 0.06 to 0.08 meq/g, or from 0.08 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g. The OH function concentration may be determined by proton NMR in DMSO-D₆, according to the protocol described in the article below: “Reactivity of isocyanates with urethanes: Conditions for allophanate formation”, Lapprand et a., Polymer Degradation and Stability, Volume 90, No. 2, 2005, 363-373.

Very advantageously, the TPU is not crosslinked.

### TPU and PEBA Foam

Advantageously, the amount of polyamide blocks in the foam is at least 15% by weight, preferably at least 20% by weight, more preferably at least 25% by weight, more preferably at least 30% by weight, more preferably at least 35% by weight (relative to the total weight of the foam). The amount of polyamide blocks in the foam may be determined by proton NMR in a TFA/CDCl₃ (¼ v/v) mixture, preferably using a Broker A M 500 spectrometer, according to the protocol described in the article “Synthesis and characterization of poly(copolyethers-block-polyamides)—II. Characterization and properties of the multiblock copolymers”, Maréchal et al., Polymer, Volume 41, 2000, 3561-3580 (the signal assignment being performed using FIG. 5 of said article).

The amount of rigid blocks of the thermoplastic polyurethane in the foam is preferably less than or equal to 50% by weight, more preferably less than or equal to 35% by weight, more preferably less than or equal to 25% by weight, more preferably less than or equal to 15% weight, relative to the total weight of the foam. The amount of rigid blocks of thermoplastic polyurethane in the foam may be measured by proton NMR in DMSO-D₆, according to the protocol described in the article: “Reactivity of isocyanates with urethanes: Conditions for allophanate formation”, Lapprand et al., Polymer Degradation and Stability, Volume 90, No. 2, 2005, 363-373.

The amounts indicated above afford the foam a lower density, greater flexibility and better rebound resilience.

The foam according to the invention preferably comprises from 40% to 95% by weight of PEBA, and from 5% to 60% by weight of TPU, more preferentially from 50% to 90% by weight of PEBA, and from 10% to 50% by weight of TPU, relative to the total weight of the foam. More advantageously, the foam according to the invention comprises from 55% to 80% by weight of PEBA, and from 20% to 45% by weight of TPU, more preferentially from 60% to 75% by weight of PEBA, and from 25% to 40% by weight of TPU, relative to the total weight of the foam. In certain embodiments, the foam comprises from 40% to 45% by weight of PEBA, and from 55% to 60% by weight of TPU, or from 45% to 50% by weight of PEBA, and from 55% to 50% by weight of TPU, or from 50% to 55% by weight of PEBA, and from 45% to 50% by weight of TPU, or from 55% to 60% by weight of PEBA, and from 40% to 45% by weight of TPU, or from 60% to 65% by weight of PEBA, and from 35% to 40% by weight of TPU, or from 65% to 70% by weight of PEBA, and from 30% to 35% by weight of TPU, or from 70% to 75% by weight of PEBA, and from 25% to 30% by weight of TPU, or from 75% to 80% by weight of PEBA, and from 20% to 25% by weight of TPU, or from 80% to 85% by weight of PEBA, and from 15% to 20% by weight of TPU, or from 85% to 90% by weight of PEBA, and from 10% to 15% by weight of TPU, or from 90% to 95% by weight of PEBA, and from 5% to 10% by weight of TPU, relative to the total weight of the foam.

Advantageously, the foam contains a total flexible block content of PEBA(s) and TPU(s) of between 30% and 80% by weight, preferably between 40% and 75% by weight, relative to the total weight of the foam. The total flexible block content may be determined by nuclear magnetic resonance (NMR), as described above. In particular, these flexible blocks comprise the polyether blocks of the PEBA and the flexible blocks of the TPU.

The molar ratio of the urethane functions to the NH₂ amine functions of the assembly consisting of at least one polyamide block-polyether block copolymer comprising amine chain ends and of at least one thermoplastic polyurethane, in the foam according to the invention, may be from 15 to 350, preferably from 25 to 250, even more preferably from 40 to 200. The amine function concentration and urethane function concentration may be determined by ¹³C NMR in DMSO-D₆ as described in the article below: “Reactivity of isocyanates with urethanes: Conditions for allophanate formation”, Lapprand et al., Polymer Degradation and Stability, Volume 90, No. 2, 2005, 363-373.

Advantageously, the TPU and PEBA foam according to the invention comprises at least a portion of the total polyamide block-polyether block copolymer covalently bonded to thermoplastic polyurethane via a urea function.

Preferably, the foam according to the invention has a urea function concentration of from 0.001 meq/g to 0.1 meq/g, preferably from 0.003 meq/g to 0.08 meq/g, more preferably from 0.005 meq/g to 0.05 meq/g. The urea function concentration in the foam may be from 0.001 to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.08 meq/g, or from 0.08 to 0.1 meq/g. The urea function concentration may be measured by ¹³C NMR in DMSO-D₆, as described in the article “Reactivity of isocyanates with urethanes: Conditions for allophanate formation”, Lapprand et al., Polymer Degradation and Stability, Volume 90, No. 2, 2005, 363-373. The signals corresponding to the carbonyl groups of urethane and urea functions are integrated so as to determine a urea function content, and the signal assignment is performed using FIG. 6 of said article.

Advantageously, the foam according to the invention has an NH₂ function concentration of from 0.01 meq/g to 1 meq/g, preferably from 0.02 meq/g to 0.4 meq/g.

The foam may have an NH₂ function concentration of from 0.01 to 0.015 meq/g, or from 0.015 to 0.02 meq/g, or from 0.02 to 0.025 meq/g, or from 0.025 to 0.03 meq/g, or from 0.03 to 0.035 meq/g, or from 0.035 to 0.04 meq/g, or from 0.04 to 0.045 meq/g, or from 0.045 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g, or from 0.6 to 0.7 meq/g, or from 0.7 to 0.8 meq/g, or from 0.8 to 0.9 meq/g, or from 0.9 to 1 meq/g. The NH₂ function concentration may be measured by potentiometric assay. This assay may for example be carried out in the following manner: the PEBAs are first dissolved in m-cresol at 80 °C and then the terminal NH₂ functions are assayed with a perchloric acid solution.

In one embodiment, the foam according to the invention comprises urea and NH₂ functions. Preferably, the foam according to the invention comprises more urea functions than NH₂ functions.

Preferably, the portion of the polyamide block-polyether block copolymer covalently bonded to thermoplastic polyurethane via a urea function represents 10% or less by weight, more preferably 5% or less by weight, more preferably 3% or less by weight, more preferentially 2% or less by weight, of the amount of the polyamide block-polyether block copolymer.

The foam according to the invention may consist essentially of, or consist of, the at least one polyamide block-polyether block copolymer and the at least one thermoplastic polyurethane and optionally a blowing agent, in the foam matrix and/or in the foam pores, notably in the case of a closed-cell foam. The foam matrix may consist essentially of, or consist of, the at least one TPU and the at least one PEBA. The foam may also comprise degradation products of a blowing agent (particularly in its matrix), in particular when a chemical blowing agent has been used to form the foam.

Alternatively, the foam may comprise one or more additives, for example ethylene-vinyl acetate copolymers or EVA (for example those sold under the name Evatane® by SK Chemical), or ethylene-acrylate copolymers, or ethylene-alkyl (meth)acrylate copolymers, for example those sold under the name Lotryl® by SK Chemical. These additives can serve to adjust the hardness of the foamed part, its appearance and its comfort. Other additives that are suitable for the invention include pigments (such as TiO₂ and other compatible colored pigments), adhesion promoters (to improve the adhesion of the foam to other materials), fillers (for example calcium carbonate, barium sulfate and/or silicon oxide), nucleating agents (in particular in pure or concentrated form, for example CaCO₃, ZnO, SiO₂, or combinations of two or more thereof), rubbers (to improve rubber elasticity, such as natural rubber, SBR, polybutadiene and/or ethylene propylene terpolymers), stabilizers (for example antioxidants, UV absorbers and/or flame retardants), processing aids (for example stearic acid), antioxidants, notably phenolic antioxidants, such as Irganox from Ciba Geigy Inc. The additives may be present in a content of from 0 to 30% by weight, preferentially from 0.1% to 20% by weight, more preferably from 0.2% to 10% by weight, relative to the total weight of the foam.

According to one embodiment, the foam does not comprise any crosslinking agents. Advantageously, the foam is a non-crosslinked foam.

The foam according to the invention preferably has a density of less than or equal to 800 kg/m³, more preferably less than or equal to 600 kg/m³, more preferentially less than or equal to 400 kg/m³, even more preferentially less than or equal to 300 kg/m³, and particularly preferably less than or equal to 230 kg/m³. It may, for example, have a density of from 25 to 600 kg/m³ and more particularly preferably from 50 to 300 kg/m³. The density of the foam may be from 25 to 100 kg/m³, or from 100 to 200 kg/m³, or from 200 to 250 kg/m³, or from 250 to 300 kg/m³, or from 300 to 400 kg/m³, or from 400 to 500 kg/m³, or from 500 to 600 kg/m³, or from 600 to 800 kg/m³. The density may be controlled by adapting the parameters of the manufacturing process. The density may be measured at 23 °C according to the standard ISO 1183-1.

Preferably, the foam according to the invention has an Asker C hardness of from 20 to 90, preferably from 25 to 70. In particular, the Asker C hardness of the foam may be from 20 to 25, or from 25 to 30, or from 30 to 40, or from 40 to 50, or from 50 to 60, or from 60 to 70, or from 70 to 80, or from 80 to 90. The Asker C hardness may be determined at 23 °C, after 15 seconds, according to the standard ISO 7619-1.

Preferably, the foam has a rebound resilience greater than or equal to 50%, preferably greater than or equal to 55%. The rebound resilience is measured according to the standard ISO 8307:2007, but using an 18.8 g ball.

Preferably, this foam has a compression set, according to the standard ISO 7214, of less than or equal to 65%, preferably less than or equal to 50%, for example less than or equal to 45%, or less than or equal to 40%, or less than or equal to 35%. The residual strain is measured after a 25% compression applied for 70 h at 23 °C followed by relaxation for 30 minutes.

Preferably, this foam also has excellent properties in terms of fatigue strength and dampening.

Preferably, this foam also has good resistance to tearing and to crack propagation.

The foam according to the invention may be used for manufacturing sports equipment, such as sports shoe soles, ski shoes, midsoles, insoles or functional sole components, in the form of inserts in the various parts of the sole (for example the heel or the arch), or shoe upper components in the form of reinforcements or inserts into the structure of the shoe upper, or in the form of protections.

It may also be used for manufacturing balls, sports gloves (for example football gloves), golf ball components, rackets, protective elements (jackets, helmet interior elements, shells, etc.).

The foam according to the invention has advantageous impact-resistance, vibration-resistance and anti-noise properties, combined with haptic properties suitable for capital goods. It may thus also be used for manufacturing railway rail soles, or various parts in the motor vehicle industry, in transport, in electrical and electronic equipment, in construction or in the manufacturing industry.

According to advantageous embodiments, the foam objects according to the invention can be readily recycled, for example by melting them in an extruder equipped with a degassing outlet (optionally after having chopped them into pieces).

### Preparation of the Foam

The foam according to the invention can be prepared by mixing a polymer composition comprising at least one TPU and at least one PEBA comprising amine chain ends with a blowing agent (and optionally with one or more additives), followed by performing a foaming step.

The blowing agent may be a chemical or physical agent, or may also consist of any type of hollow object or any type of expandable microsphere. Preferably, it is a physical agent, for instance dinitrogen or carbon dioxide, or a hydrocarbon, chlorofluorocarbon, hydrochlorocarbon, hydrofluorocarbon or hydrochlorofluorocarbon (saturated or unsaturated) or a mixture thereof. For example, butane or pentane may be used. Preferably also, it may be a chemical agent, for instance azodicarbonamide or mixtures based on citric acid and sodium hydrogen carbonate (NaHCO₃) (such as the Hydrocerol® product range from Clariant).

In certain embodiments, a physical blowing agent is used and is mixed with the polymer composition in the molten state. The physical blowing agent may be in liquid or supercritical form and is then converted into the gas phase during the foaming step. Foaming may be brought about by a drop in pressure, for example resulting from the exit of an extruder.

Advantageously, the mixture of polymer composition and blowing agent is injected into a mold and foaming is performed in the mold. Foaming may be brought about by opening the mold, by under-dosing, by applying a gas counter-pressure, by a breathable mold or by a mold equipped with a Variotherm® system. This technique allow the direct production of three-dimensional foamed objects with complex geometries. They are also techniques that are relatively simple to perform, notably in comparison with certain processes of melting foamed particles: specifically, filling of the mold with foamed polymer granules followed by melting of the particles to ensure the mechanical strength of the parts without destroying the structure of the foam are complex operations.

In alternative embodiments, the polymer composition is used so as to create a preform. This preform may be prepared via compression molding, extrusion, injection molding, lamination or 3D printing processes. Preferentially, the preform is produced by extrusion or injection molding. This preform, in its solid state, is placed in contact with a physical blowing agent in gaseous or supercritical form. The physical blowing agent impregnates the solid preform, preferably by applying a positive pressure. Preferably, foaming is performed in an autoclave, preferentially at a temperature slightly below the melting point of the polymer composition. Preferentially, the pressure inside the autoclave is maintained between 0.20 and 50 MPa during foaming. Advantageously, preform foaming is contained within a mold.

Other foaming techniques that may be used notably include batch foaming, extrusion foaming, such as single-screw or twin-screw extrusion foaming, and microwave foaming.

In a particularly preferred manner, the polymer composition comprising the TPU and the PEBA is prepared prior to being mixed with the blowing agent. Preferably, the polymer composition is an alloy of TPU and PEBA. The term “alloy” means a mixture that is homogeneous (macroscopically, i.e. to the naked eye).

According to a first advantageous variant, the polymer composition can be prepared via a process comprising a step of mixing the polyamide block-polyether block copolymer comprising amine chain ends and the thermoplastic polyurethane in the molten state. Such a preparation process makes it possible, under certain mixing time and temperature conditions, for a reaction to take place between the amine functions of a portion of the polyamide block-polyether block copolymer and the urethane functions of the TPU, which improves the compatibility between the polyamide block-polyether block copolymer and the thermoplastic polyurethane.

The mixing of TPU and PEBA may take place in any device for mixing, kneading or extruding plastics in the molten state known to those skilled in the art, such as an internal mixer, an open mill, an extruder, such as a single-screw extruder or a counter-rotating or corotating twin-screw extruder, a co-kneader, such as a continuous co-kneader, or a stirred reactor. Preferably, the mixing takes place in an extruder or a co-kneader, more preferentially in an extruder, even more preferentially in a twin-screw extruder.

Preferably, the mixing is performed at a temperature greater than or equal to 160 °C, preferably from 160 °C to 300 °C, more preferably from 180 °C to 260 °C. These temperature ranges allow optimum reaction between the polyamide block-polyether block copolymer comprising amine chain ends and the thermoplastic polyurethane, and thus better compatibility of the two polymers.

Advantageously, the mixing is performed for a time of from 30 seconds to 15 minutes, preferably from 40 seconds to 10 minutes. Preferably, the mixing is performed with stirring. These mixing conditions allow optimum reaction between the polyamide block-polyether block copolymer comprising amine chain ends and the thermoplastic polyurethane, and thus better compatibility of the two polymers.

The step of mixing the TPU with the PEBA may involve mixing the polyamide block-polyether block copolymer comprising amine chain ends and the thermoplastic polyurethane, in the molten state, with additives.

According to another advantageous variant, the polymer composition may be prepared by introducing the polyamide block-polyether block copolymer comprising amine chain ends during the synthesis of the thermoplastic polyurethane. In such a preparation process, the polyamide block-polyether block copolymer comprising amine chain ends is used as an isocyanate-reactive compound (as described above in the “Thermoplastic polyurethane (TPU)” section), optionally in addition with another isocyanate-reactive compound, preferably a polyol as described above.

Thus, the preparation process may comprise the steps of:
introducing thermoplastic polyurethane precursors (i.e. at least one polyisocyanate, at least one chain extender, and optionally at least one isocyanate-reactive compound) into a reactor;
introducing the polyamide block-polyether block copolymer comprising amine chain ends into the reactor; and
synthesizing the thermoplastic polyurethane in the reactor in the presence of the polyamide block-polyether block copolymer comprising amine chain ends, so as to obtain the polymer composition.

Such a preparation process allows the NH₂ amine functions of part of the polyamide block-polyether block copolymer to react with the isocyanate functions of part of the polyisocyanate during the synthesis of the thermoplastic polyurethane, leading to the formation of covalent bonds between the polyamide block-polyether block copolymer and the thermoplastic polyurethane, thereby improving the compatibility between the polyamide block-polyether block copolymer and the thermoplastic polyurethane.

The steps of introducing the thermoplastic polyurethane precursors and of introducing the polyamide block-polyether block copolymer comprising amine chain ends may be simultaneous or performed in any order. A catalyst, in particular as described above, may also be introduced into the reactor.

The reactor may be a batch reactor, a stirred reactor, a static mixer, an internal mixer, an open mill, an extruder, such as a single-screw extruder or a counter-rotating or corotating twin-screw extruder, a continuous co-kneader, or a combination thereof. Preferably, the reactor is an extruder, more preferably a twin-screw extruder.

Preferably, the step of synthesizing the thermoplastic polyurethane (in the presence of the polyamide block-polyether block copolymer comprising amine chain ends) is performed at a temperature greater than or equal to 160 °C, preferably from 160 °C to 300 °C, and more preferably from 180 °C to 270 °C. These temperature ranges allow optimum reaction between the polyamide block-polyether block copolymer comprising amine chain ends and the thermoplastic polyurethane, and thus better compatibility of the two polymers.

One or more additives may be placed in the reactor (at any time during the process) and mixed with the thermoplastic polyurethane and the polyamide block-polyether block copolymer in the reactor.

Whichever variant is used, the preparation process may comprise a step of forming the mixture of TPU and PEBA into shape in the form of granules or powder. When the mixture is formed into a powder, it is preferably first formed into granules and the granules are then ground into powder. Any type of mill can be used, such as a hammer mill, a pin mill, an attrition disc mill or an impact classifier mill.

In the processes for preparing the polymer composition described above, all the features described above in relation to the polyamide block-polyether block copolymer and the thermoplastic polyurethane (notably their nature, amount, OH, COOH and/or amine function concentration, etc.) can be applied in a similar manner to the polyamide block-polyether block copolymer and the thermoplastic polyurethane used in these processes.

### Examples

The following examples illustrate the invention without limiting it.

The following polymers were used:
PEBA 1: PEBA copolymer comprising PA 11 blocks with a number-average molar mass of 1000 g/mol and PTMG blocks with a number-average molar mass of 1000 g/mol, with a Shore D hardness of 40. The PEBA copolymer does not comprise any NH₂ functions.
PEBA 2: PEBA copolymer comprising PA 11 blocks with a number-average molar mass of 1000 g/mol and PTMG blocks with a number-average molar mass of 1000 g/mol, with a Shore D hardness of 40. The PEBA copolymer has an NH₂ function content of 0.032 meq/g.
TPU: TPU containing rigid blocks based on 4,4′-MDI and 1,4-BDO (1,4-butanediol) and flexible polyether blocks (PTMG), with a Shore A hardness of 85.

A polymer composition 1 was prepared by mixing 65% by weight of PEBA 1 and 35% by weight of TPU using an 18 mm ZSK twin-screw extruder (Coperion). The barrel temperature was set at 210 °C and the screw speed was 280 rpm with a flow rate of 8 kg/h. The composition was then dried under reduced pressure at 80 °C so as to achieve a moisture content of less than 0.04%.

A polymer composition 2 was prepared by mixing 65% by weight of PEBA 2 and 35% by weight of TPU using an 18 mm ZSK twin-screw extruder (Coperion). The barrel temperature was set at 210 °C and the screw speed was 280 rpm with a flow rate of 8 kg/h. The composition was then dried under reduced pressure at 80 °C so as to achieve a moisture content of less than 0.04%.

### Foam Evaluation

Foams were then prepared:
Foam 1 (comparative): manufactured from polymer composition 1.
Foam 2 (according to the invention): manufactured from polymer composition 2.

The 15 mm thick foams were prepared using an Arburg Allrounder 520A 150T injection press, with a Trexel series II physical blowing agent injection system. This machine uses the Mucell® technology with partial mold opening (core-back process). The operating parameters are as follows:
Barrel temperature: 250 °C
Mold geometry (mm): 200×100×1.6 mm
Injection speed: 120 cm³/s
Maintenance time before opening the mold: 1 s
Maintenance pressure: 25.0 MPa
Cooling time: 240 s
Mold temperature: 15 °C
Mold opening length: 15 mm

The blowing agent used is dinitrogen (N₂), introduced to a proportion of 0.7% by weight.

The following foam properties were evaluated:
Density: according to the standard ISO 1183-1, at 23 °C, using the method of vertical thrust in water; five repetitions were performed.
Δ density: characterizes the homogeneity of the foam and corresponds to the difference in density of the foamed part between the point closest to the injection point and the point furthest from the injection point; the lower this value, the more homogeneous the foam.
Rebound resilience: according to the standard ISO 8307, except that an 18.8 g ball was used (a steel ball weighing 18.8 g and with a diameter of 16 mm is dropped from a height of 500 mm onto a foam sample, the rebound resilience then corresponds to the percentage of energy restored to the ball, or percentage of the initial height reached by the ball on rebound); five repetitions were performed.
Asker C hardness (15 s): according to the standard ISO 7619-1, measured with a Hildebrand Asker C hardness tester.
Compression test: according to the standard ISO 3386-1, measured using a Zwick compression machine. Foam samples measuring 50×50×15 mm are subjected to four compression cycles to 70% strain, with a displacement speed of 100 mm/min at a temperature of 23 °C. Measurements on the fourth compression cycle are representative of the foam's intrinsic behavior, and stresses corresponding to 25%, 40% and 50% strain are recorded.
The NH₂ function concentration may be measured by potentiometric assay. This assay is carried out in the following manner: the PEBAs are first dissolved in m-cresol at 80 °C and then the terminal NH₂ functions are assayed with a perchloric acid solution.

The results are shown in the following table:

TABLE 1

| | | Foam 1 | Foam 2 |
|---|---|---|---|
| | | (comparative) | (invention) |
| Density (kg/m³) | Mean | 0.216 | 0.187 |
| | Standard | 0.004 | 0.004 |
| | deviation | | |
| Δ density (kg/m³) | | 0.004 | 0.004 |
| Rebound resilience (%) | Mean | 58 | 59 |
| | Standard | 2 | 3 |
| | deviation | | |
| Asker C hardness (15 s) | | 58 | 59 |
| Compressive stress at | 25% | 88 | 81 |
| different strains (kPa) | 40% | 165 | 157 |

The foam according to the invention has a lower and more homogeneous density than the comparative foam prepared from composition 1 not comprising any amine chain ends. In addition, the foam according to the invention has greater flexibility, illustrated by the Asker C hardness, and lower compressive stresses than those of the comparative foam, while at the same time having similar rebound resilience.

1. A polymer foam comprising:
at least one thermoplastic polyurethane, and
at least one polyamide block-polyether block copolymer comprising amine chain ends, as detected by potentiometric assay in metacresol using a 0.02N perchloric acid solution.

2. The foam as claimed in claim 1, in which at least a portion of the total polyamide block-polyether block copolymer is covalently bonded to a thermoplastic polyurethane molecule via a urea function.

3. The foam as claimed in claim 2, in which the urea function concentration, as measured by ¹³C NMR in DMSO-D₆, is from 0.001 meq/g to 0.1 meq/g.

4. The foam as claimed in claim 1, in which the polyamide block-polyether block copolymer has an NH₂ amine function concentration, as measured by potentiometric assay in metacresol using a 0.02N perchloric acid solution, of from 0.002 meq/g to 0.2 meq/g.

5. The foam as claimed in claim 1, in which the amount of polyamide blocks, as measured by proton NMR in a TFA/CDCl₃ (¼ v/v) mixture, is at least 15% by weight, relative to the total weight of the foam.

6. The foam as claimed in claim 1, in which the polyamide block-polyether block copolymer comprises at least 30% by weight, relative to the total weight of the copolymer, as measured by proton NMR in a TFA/CDCl₃ (¼ v/v) mixture.

7. The foam as claimed in claim 1, in which the at least one thermoplastic polyurethane is a copolymer containing rigid blocks and flexible blocks, the content of rigid blocks in the thermoplastic polyurethane, as measured by proton NMR in DMSO-D₆, being less than or equal to 90% by weight.

8. The foam as claimed in claim 1, comprising, relative to the total weight of the foam:
from 5% to 70% by weight, of the at least one thermoplastic polyurethane, and
from 30% to 95% by weight, of the at least one polyamide block-polyether block copolymer comprising amine chain ends.

9. The foam as claimed in claim 1, in which the at least one thermoplastic polyurethane is a copolymer containing rigid blocks and flexible blocks, in which:
the flexible blocks are chosen from polyether blocks, polyester blocks, polycarbonate blocks and a combination thereof; and/or
the rigid blocks comprise units derived from 4,4′-diphenylmethane diisocyanate and/or 1,6-hexamethylene diisocyanate.

10. The foam as claimed in claim 1, in which the polyamide blocks of the polyamide block-polyether block copolymer comprising amine chain ends are polyamide 11, polyamide 12, polyamide 10, polyamide 6, polyamide 6.10, polyamide 6.12, polyamide 6.13, polyamide 10.9, polyamide 10.10, polyamide 10.12 and/or polyamide 12.9 blocks; and/or the polyether blocks of the polyamide block-polyether block copolymer comprising amine chain ends are polyethylene glycol and/or polypropylene glycol and/or polytetrahydrofuran blocks.

11. The foam as claimed in claim 1, having a density, as measured at 23 °C in accordance with the standard ISO 1183-1, of less than or equal to 800 kg/m³.

12. The foam as claimed in claim 1, having an Asker C hardness, as measured at 23 °C according to the standard ISO 7619-1, of from 20 to 90.

13. A process for manufacturing a foam as claimed in claim 1, comprising the following steps:
providing a polymer composition comprising the at least one thermoplastic polyurethane and the at least one polyamide block-polyether block copolymer comprising amine chain ends;
mixing said polymer composition with a blowing agent; and
foaming the mixture of polymer composition and blowing agent.

14. The process as claimed in claim 13, in which the blowing agent is mixed with the polymer composition in the molten state.

15. The process as claimed in claim 13, in which the blowing agent is a physical blowing agent and is mixed with the polymer composition in the form of a solid preform.

16. An article formed from a foam as claimed in claim 1.
